(19) United States
(12) Patent Application Publication
(10) Pub. No.: US 2026/0141422 A1
(43) Pub. Date: May 21, 2026

(54) SYSTEM AND METHOD FOR QR CODE-BASED IDENTITY RESOLUTION AND TARGETED ADVERTISING

(71) Applicant: Robert Maniaci, Villa Park, CA (US)

(72) Inventor: Robert Maniaci, Villa Park, CA (US)

(21) Appl. No.: 19/394,418

(22) Filed: Nov. 19, 2025

Related U.S. Application Data
(60) Provisional application No. 63/722,223, filed on Nov. 19, 2024.

(51) Int. Cl. G06Q 30/0251

(52) U.S. Cl. CPC G06Q 30/0251

(57) ABSTRACT

A computer-implemented system and method for identity resolution and targeted advertising using QR codes and related digital triggers. A QR code generation module creates encoded identifiers embedded with campaign details and unique tracking links hosted on one or more servers. When a user scans a QR code, a data-collection module logs interaction data including geolocation and device information. An identity-resolution engine correlates the captured data with internal and third-party databases to generate and continuously enrich a unified user profile. A dashboard module presents enriched profiles, campaign analytics, and predictive insights, while integration interfaces automatically transmit updated identity data to marketing or analytics platforms for targeted activation. The system may further employ artificial-intelligence models, geo-fencing, MAID conversion, and privacy-management controls to deliver real-time, cross-channel identity resolution and personalized marketing actions.

### RELATED APPLICATION (PRIORITY CLAIM)

This application claims the benefit of the U.S. provisional application Ser. No. 63/722,223, filed Nov. 19, 2024, which is hereby incorporated hearing in its entirety by reference

### BACKGROUND

The present invention generally relates to Quick Response (QR) codes, and more specifically relates to a system and method which leverages QR codes to enhance marketing campaigns by integrating identity resolution and next-step solutions.

A QR code, or Quick Response code, is a type of two-dimensional barcode that can be scanned using a smartphone or a QR code reader. A typical QR code pattern consists of squares arranged on a contrasting grid, and can store a variety of information, such as URLs, contact information, text, or other data.

QR codes are designed to be quickly scanned and read, making them useful for various applications, such as marketing, product labeling, event ticketing, and more. When a user scans a QR code with their device, it typically directs them to a website, displays a message, or performs another predefined action. QR codes have gained popularity due to their ease of use and the growing prevalence of smartphones equipped with cameras.

Conventional QR code systems allow basic redirection to URLs or landing pages. Some QR code systems can collect basic user data (e.g., geolocation) but lack integration with comprehensive identity resolution platforms. Existing digital marketing tools offer user tracking but often rely on cookies or device-based identifiers without combining offline and online user interactions.

There are plenty of existing published patent and application and existing patents relating to QR codes and technology relating thereto. For example, published patent application US 2023/0098800 discloses a method and system that is used to deliver media content by ingesting input data, which includes raw household location data and marketing information. This input also contains data on physical out-of-home activities, such as advertisement exposure and visits to points of interest, along with online activity data from digital platforms. The ingestion process is pre-configured to identify a data delivery format, a schema, and a linking key within a database graph. The system processes the input data by checking for new data availability, identifying the file source, extracting the data, and storing it in the graph using the key. The data is then linked in the graph, allowing for the generation of measurements and analytics that assess exposure to and the effectiveness of media content. The system and method only dashboards/reports data and effectively provides notes on the effectiveness of out of home advertising. The data is directed to measurement, including the generation of some scores. The system and method require data to be ingested before a QR code is scanned and fails to use a string of databases, tools and pixels to infer the data. The system and method does not provide tools such as QR code builders, tracking links, page builders, and pixels that advertisers can place (and optionally add extra data to) that when scanned do not just provide analytics, but rather provide, for example, full user demographics with the ability to layer on more data, Ideal Customer Profile (ICP) of those converting or visiting, retargeting and remarketing options that are integrated and can be used either manually or automatically into various other platforms, modeling and look-a-like audience building, and a slew of next step solutions and plug ins. The system and method do not, for example, ingest touch points to create better data models to provide connection to outside remarketing that was not available previously, such as QR on receipts or the phone number linked to provide actions, etc. The system and method involve the use of control groups and most of the data comes from a pre-setup process (i.e., data ingestion pre QR code scanning by a user).

Another published patent application, US 2024/256815, discloses systems, computer-implemented methods, apparatus, and computer program products that enable adaptable QR codes for launching personalized experiences. In some embodiments that are disclosed, a system receives a QR code, client identifier, and location data from a client device. The system then identifies the corresponding merchant from multiple merchants based on the location data and QR code. Additionally, it determines the relevant client profile from a set of client profiles using the client identifier. The system uses both the identified merchant and client profile to select digital content, which is then delivered to the client device. The disclosure is directed to creating dynamic environments for a QR code and does not disclose any next step solutions. The disclosure does not provide any identifications or connections for retargeting any demographic profiles. The system does not provide any outside measurement or software to build the original campaigns or automations.

The prior art, such as the two published application discussed above, fails to leverage QR codes to enhance marketing campaigns by integrating identity resolution and next-step solutions. Conventional systems and methods do not connect users'actions with comprehensive demographic and behavioral data, enabling businesses to create highly targeted marketing campaigns. No prior system unifies trigger initiation, identity resolution, waterfall enrichment, and automated activation across all trigger types (QR, pixel, link, MAID, geofence, or future equivalents) into one system.”

### SUMMARY

An object of an embodiment of the present invention is to provide a system and method which is configured to provide QR code-based identity resolution and targeted advertising.

Another object of an embodiment of the present invention is to provide a system and method which is configured to connect users'actions with comprehensive demographic and behavioral data, enabling businesses to create highly targeted marketing campaigns.

Briefly, embodiments of the present invention provide systems and methods that are configured to provide identity resolution and targeted advertising using QR codes. This technology allows businesses to create QR codes that, when scanned by users, direct them to the business'page while gathering and analyzing user data. The system and method use the collected data to build detailed user profiles, which is viewable on a centralized dashboard. Preferably, the system and method are configured to integrate with various marketing tools and platforms to run targeted advertising campaigns. Preferably, the technology is customizable and is configured to integrate into business websites, allowing companies to track and recognize users across different marketing platforms, such as social media, email campaigns, and online ads. This helps businesses gather consistent data about their users'interactions, no matter where those interactions occur.

In some embodiments, the invention provides a computer-implemented system comprising a trigger initiation module, an identity-resolution engine, a data-enrichment module, an automation interface, and an analytics dashboard, all operating within a unified data architecture. The trigger initiation module receives an interaction event from a unique encoded identifier such as a QR code, tracking pixel, hyperlink, NFC tag, or equivalent digital trigger. Upon receipt of the event, the identity-resolution engine correlates the associated data with multiple first-party and third-party datasets—including customer relationship management (CRM) systems, enrichment APIs, and behavioral identifiers—using deterministic, probabilistic, or hybrid matching algorithms to construct a unified identity record.

The data-enrichment module performs continuous or waterfall enrichment of each identity record by sequentially or concurrently querying multiple data sources and appending additional demographic, behavioral, or transactional attributes as they become available. Enriched identity profiles are programmatically transmitted to integrated platforms, such as marketing-automation systems, advertising networks, or analytics tools, via application programming interfaces (APIs) that trigger automated next-step actions including audience creation, campaign delivery, or retargeting. The analytics dashboard provides visualization, segmentation, and predictive modeling of the continuously updated dataset and may employ artificial-intelligence or machine-learning models to generate predictive scores, look-alike audiences, or recommended engagement actions.

In certain embodiments, the system implements privacy and compliance safeguards, including hashing or pseudonymization of personally identifiable information, consent verification, and restricted-access protocols. The described architecture thereby enables real-time, privacy-compliant identity resolution and enrichment across multiple channels, unifying data ingestion, profiling, automation, and analytics within a single extensible framework.

The system is not limited to QR codes and applies equally to any encoded or digital identifier that can capture an interaction event, including future equivalent identifiers.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a block diagram of a system for QR code-based identity resolution and targeted advertising, wherein the system is in accordance with an embodiment of the present invention;

FIG. 2 is a block diagram of a method for QR code-based identity resolution and targeted advertising, wherein the method is in accordance with an embodiment of the present invention;

FIGS. 3A and 3B, collectively, provide a schematic block diagram illustrating an exemplary system architecture for cross-channel identity resolution and continuous data enrichment, showing a trigger initiation module, identity-resolution engine, enrichment module, automation interface, and analytics dashboard interconnected through a unified data framework;

FIG. 4 is a flow diagram depicting an exemplary sequence of operations in which an encoded digital trigger initiates identity resolution, followed by sequential or parallel waterfall enrichment, automated data activation, and continuous profile updating;

FIG. 5 is a conceptual view of a sample user interface displaying the dashboard module with enriched identity profiles, segmentation options, predictive-model outputs, and campaign-performance analytics;

FIG. 6 is a schematic diagram illustrating the interaction between first-party and third-party data sources, enrichment APIs, and privacy-management components within the system;

FIG. 7 illustrates the QR Code Generation Interface and shows the user-facing aspect of the system (i.e., a user interface screen mockup with input fields for campaign name, tags, metadata, and “Generate QR Code” button (i.e., a depiction of a generated QR code (symbolic square) linked to a UR));

FIG. 8 illustrates the Dashboard Interface;

FIG. 9 illustrates the data flow/network environment; and

FIG. 10 illustrates geo-fencing and MAID conversion.

### DESCRIPTION OF ILLUSTRATED EMBODIMENTS

While this invention may be susceptible to embodiment in different forms, there are shown in the drawings and will be described herein in detail, specific embodiments with the understanding that the present disclosure is to be considered an exemplification of the principles of the invention and is not intended to limit the invention to that as illustrated.

Embodiments of the present invention comprise a system and method that is configured to provide identity resolution and targeted advertising using QR codes.

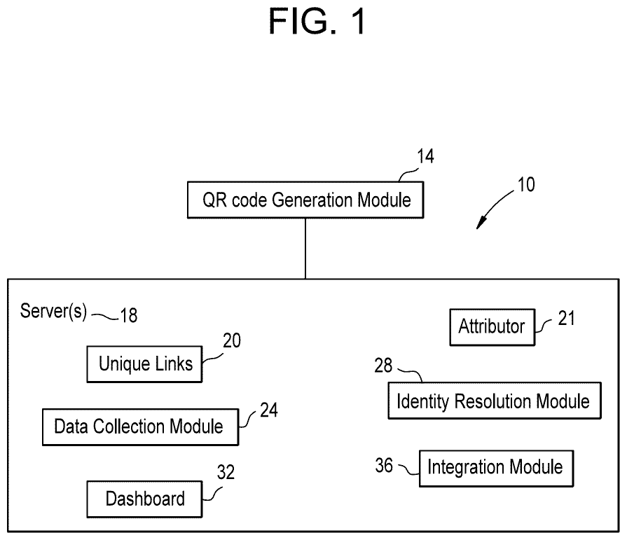

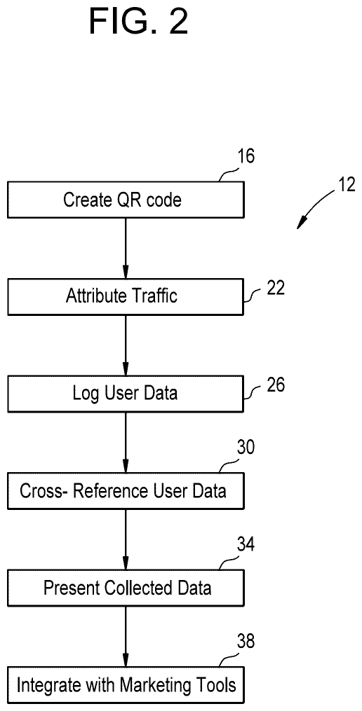

FIG. 1 is a block diagram of a system 10 for QR code-based identity resolution and targeted advertising, wherein the system 10 is in accordance with an embodiment of the present invention. Similarly, FIG. 2 is a block diagram of a method 12 for QR code-based identity resolution and targeted advertising, wherein the method is in accordance with an embodiment of the present invention. In effect, the system 10 shown in FIG. 1 is used to perform the method 12 shown in FIG. 2. As such, FIGS. 1 and 2 can be viewed simultaneously while reading the following description.

As shown in FIG. 1, the system 10 comprises a digital identifier, such as a QR code, generation module 14 that is configured to allow a user to create digital identifiers, such as QR codes, with embedded tags and campaign details (see block 16 in FIG. 2). The system 10 also comprises one or more servers 18 which host unique links 20 for each digital identifier (such as a QR code) and attribute traffic (via Attributor 21 in FIG. 1) to specific campaigns (see block 22 in FIG. 2). The one or more servers also comprise a Data Collection Module 24 that is configured to log user data (see block 26 in FIG. 2), preferably including geolocation and tracking data. Preferably, the Data Collection Module 24 is configured to convert MAIDs into identity-graphed users and track users within geo-fenced areas.

The system 10 also comprises an Identity Resolution Module 28 that is preferably configured to cross-reference the data that was obtained from the QR code scan with databases, preferably both internal and those of third parties (see block 30 in FIG. 2). Preferably, the Identity Resolution Module 28 is configured to collect demographic, contact, and behavioral data from multiple sources.

The system 10 also comprises a Dashboard Generator 32 that generates and populates a dashboard, wherein the system uses the dashboard to present collected data (see block 34 in FIG. 2) and support the execution of targeted marketing campaigns. Preferably, the system 10 also comprises an Integration Module 36 that is configured to integrate with various marketing tools for next-step solutions (see block 38 in FIG. 2).

In other words, the system 10 shown in FIG. 1 generates digital identifiers, such as QR codes, embedded with necessary tags and campaign details, wherein each digital identifier (such as a QR code) is associated with a unique link. The system 10 is configured to perform data collection and identity resolution. Specifically, when a user scans the digital identifier (such as a QR code), the scanning device (such as a smartphone) directs to a server which checks databases and partnerships for matching user records. Preferably, the system 10 also logs geolocation data relating to the user, device language, browser data, and social media profiles, effectively building a comprehensive user profile from a single scan of the digital identifier (such as a QR code). Preferably, the system 10 is configured to perform an identity resolution process which comprises collecting demographic information, contact details, and behavioral data from multiple sources thereby resulting in a more complete user profile that initially existed when the digital identifier (such as a QR code) was scanned. In other words, the digital identifier (such as a QR code) results in certain information about the user being collected, but then that information is supplemental using databases to create a more complete user profile.

Preferably, the system 10 is configured to present the collected data (see block 34 in FIG. 2) in a way that is easy to sort and understand, such as via an accessible dashboard 32. Preferably, the dashboard 32 displays information such as contact details, demographic reports, campaign performance metrics, and enrichment options for additional data. Preferably, the dashboard 32 is configured such that users can tag, note, and filter leads, creating custom actions for different lead categories. Preferably, campaign details and tags that were created while creating the digital identifier (such as a QR code) are also included. Preferably, the system 10 is configured to offer various next-step solutions, such as integration with local bulk mailers, individualized postcards and email follow-ups, AI-driven copywriting tools, audience finding tools to target users with similar attributes, social media platforms, design templates, print creators, TV placements, audio placements, and more, and campaign recommendations based on data analysis.

Preferably, the system 10 is also configured to provide mobile advertising identification (MAID) and geo-fencing. Specifically, preferably the system 10 converts MAIDs from devices into identity-graphed users, and tracks users within geo-fenced areas to provide location-based marketing insights. This effectively allows businesses to see who was in a specific area and target them with relevant ads.

Regarding the dashboard 32, preferably the system 10 is configured to provide that the dashboard 32 presents the collected data very dynamically and allows for advanced sorting. For example, the system 10 can be configured to provide the dashboard 32 with some, or all, of the functionality discussed below.

For example, the dashboard 32 could be configured to attach to 3^{rd} party databases, send to social media campaigns, create and send mail (like postcards), and create unique mailers which are either printed or sent electronically. The dashboard 32 could be configured to allow a user to schedule the release of the defined marketing campaigns. The dashboard 32 could be configured to create graphs and groupings which characterize the users who scan the digital identifier (such as a QR code). The dashboard 32 could be configured to upload e-mail collections and match e-mail addresses with user data. The dashboard 32 could be configured to allow a user to add an audience and define the characteristics in that audience such that the dashboard displays everyone who matches the defined audience. The dashboard 32 could be configured to connect with partners and target via marketing. Preferably, the system 10 integrates with other databases and the dashboard is configured to overlay data on a map, display carrier routes, narrow by characteristics of the users, define a mail drop, and show the price for the proposed mail drop.

Regarding the at least one or more servers 18 indicated in FIG. 1, that one or more servers could either relate to the business whose customer or user initially scanned the digital identifier (such as a QR code) or could relate to a third party who effectively crunches the data and presents the business with the dashboard 32. In that case, the digital identifier (such as a QR code) would direct to the third party's server(s) and then effectively redirect to the business whose customer or user initially scanned the digital identifier (such as a QR code) for data display on the dashboard.

One specific application in which the present invention can be used is to have the digital identifiers (such as QR codes) discussed hereinabove be displayed on receipts. In that case, the receipt is given to a user, the user scans the digital identifier (such as a QR code) to pay, take advantage of a promotional discount, etc. In that case, the business not only gets the payment, but also effectively gains a list of clients to whom to send coupons, target outside look alike audiences for more business, find matching neighborhoods or expansion locations, send text or email on slow days to top customers to bring in more business, etc.

In one embodiment, businesses use the system 10 disclosed herein to generate customized digital identifiers (such as QR codes) and effectively embed the technology disclosed herein directly on their websites. When users scan the digital identifier (such as a QR code) or interact with the embedded technology, data such as geolocation, device language, and social media profiles are collected. The collected data is cross-referenced with both internal and external databases to build detailed user profiles. A centralized dashboard 32 displays this data, providing insights into user behavior and allowing businesses to execute targeted campaigns. Preferably, the system 10 supports integration with multiple marketing platforms and tools, facilitating direct mail, digital ads, AI-driven content creation, and more.

In another embodiment, businesses generate customized webpages with their desired URLs and layouts. When users view their link or page, data such as geolocation, device language, and social media profiles are collected as well as the URLs they are interested in. The collected data is cross-referenced with both internal and external databases to build detailed user profiles. A centralized dashboard 32 displays this data, providing insights into user behavior and allowing businesses to execute targeted campaigns. Preferably, the system supports integration with multiple marketing platforms and tools, facilitating direct mail, digital ads, AI-driven content creation, and more.

Embodiments of the present invention provide a system and method for digital identifier (such as a QR code)-based identity resolution and targeted advertising. The system and method enable businesses to connect offline user interactions (like scanning a QR code) with online data to create comprehensive user profiles and deliver highly targeted marketing campaigns. This also allows businesses to analyze detailed audience behavior and optimize product offerings, marketing strategies, and customer experiences across various channels.

The system disclosed herein could be provided to a customer as software as a service (SaaS) in which case the customer would log in, create digital identifiers (such as QR codes) using the digital identifier generation module, use the digital identifiers (such as QR codes) in its business, and then view the collected data on the dashboard. The collected data would be a combination of the data obtained from the digital identifier (such as a QR code) scan itself and the supplementation of that data using one or more databases to create a more complete user profile.

Embodiments of the present invention offer systems and methods designed for identity resolution and targeted advertising through the use of digital identifiers (such as QR codes) and links. This technology enables businesses to generate digital identifiers (such as a QR codes) and links that, when interacted with, direct users to the company's webpage while collecting and analyzing user data. The system leverages the gathered data to create detailed user profiles, accessible via a centralized dashboard. Ideally, the system is designed to integrate with various marketing tools and platforms to execute targeted advertising campaigns. Additionally, the technology is customizable and can be embedded into business websites, allowing companies to track and recognize users across multiple marketing channels such as social media, email campaigns, and online advertisements. This ensures businesses gather consistent data on user interactions, regardless of where those interactions take place.

A specific embodiment provides that the consumer wears either a virtual reality (VR) headset or augmented reality (AR) glasses. While VR headsets completely take over your vision to give you the impression that you are somewhere else, AR glasses add to it. AR glasses are transparent, letting you see everything in front of you as if you are wearing a pair of clear glasses. An embodiment of the present invention provides that as the wearer wears the headset and looks at a digital identifier (such as a QR code), preview, pop up, coupon, image, etc., the device effectively tracks the eyes and selects it, documents the emotion, the time, etc. Once an object is selected or interacted with (i.e., by looking at it), the system performs the process discuss above with regard to identity resolution and next step solutions. Regarding AR, preferably the system is configured for free movement while projecting images over whatever a person looks at.

Another embodiment provides a plugin that is configured for integration natively into, for example, payment processing, online shopping, and/or website building.

Another embodiment relates to automation workflows in that the system is configured to import to a third-party system in order to provide new integration and functionality with that third party system.

Another embodiment relates a process which detects interaction with bots. Specifically, fake 1×1 pixels are placed on a web page. Any traffic that flows from a fake 1×1 pixel is guaranteed to be from a bot rather than from human interaction and, therefore, can be assumed to be undesirable or irrelevant interaction. In response, one can stop dealing with the partner that is associated with that traffic.

Another embodiment relates to guaranteeing that you have engaged recipients of marketing materials. For example, for a home improvement company client, the master database can be scanned for people that would most likely be interested in home improvement products and/or services. Once those people are identified, a text message or e-mail can be sent to those people. As such, a portion of the master database can be marketed to a company as an advertising unit that can be purchased by a company that is interested in performing direct marketing to recipients that are most likely to be receptive to their message.

Another embodiment relates to newsletter integration. Specifically, the ability to buy traffic as well as place an advertising unit for selling traffic inside of a newsletter. As such, one can place an advertising unit inside of an e-mail, and one can put any advertisements for third party advertising that one wants to cross promote in a newsletter and one does not have to author any content. One merely places the container in the newsletter, and the container ultimately performs identity resolution so viewers of the newsletter can be tracked and ultimately monetized using the next step solutions discussed above.

Another embodiment provides for functioning with in-app browsers to provide identity resolution. If the transition from the application to the browser blocks the transmission of captured data, then the system either requires a user to click to move on or initiates a delay to allow the transmission of captured data in order to successfully perform the identity resolution.

Another embodiment provides for identity resolution regarding locked or wrapped links, such as Docusign® documents, which require identity validation.

Another embodiment provides identity resolution for live streams, wherein a viewer or a producer of a live stream is checked against the master database of the system. If the user is identified, identity resolution continues, and then a more complete profile is then associated with that user. Once the user is identified, that user can be target marketed on other platforms. For example, if a user watches a TikTok® live stream or video, and that user is identified as being a cat lover, cat-related advertisements can be pushed to that user on other platforms, such as YouTube®. The same thing can be done for users who, for example, listen to a podcast, i.e., the user can be checked against the database and next steps taken regarding target marketing, etc.

Another embodiment provides that the database of the system is used to perform identity resolution on a missed or received phone call. Once the caller is identified, the user's profile can be enriched and used to target market that caller.

Another embodiment provides that the system keeps track of how many times a user visits a web page and keeps track of how many times the user views a specific product. The system is preferably configured to provide web visit counts and product viewing counts on demand, such as on the dashboard discussed hereinabove.

As discussed above, the QR code generation module 14 is preferably configured to allow a user to create QR codes with embedded tags and campaign details. Another embodiment provides that this module has still other functionality, such as the ability to, for example, generate videos, files or code for embedding in a web page and providing identity resolution based on views and interactions on any domain.

Another embodiment provides the mapping and integrations of various out of home placements such as billboards, benches, buses, etc. This could also be combined with dash boarded data or databases, that would allow a user to not only find ideal out of home inventory, but also allow them to find similar markets and recommend other placements to them for enhanced targeting. Similarly, these mapped placement points could be given a geo-fenced area that is determined based on the size and placement of their location, that could help in dashboarding and collecting interaction data and probability that the placement was seen.

Another embodiment effectively provides trucking or device builds through the use of short range radio technology (such as Bluetooth®) to identify devices/users within the area of detection (i.e., the radius). Integrating such devices creates a geo fenced area around, for example, a billboarded truck or office location, that detects users who broke such geo-fence, determining the likelihood of them seeing or interacting with the ad or location. Preferably, the data is available in the ways mentioned above and dash boarded (i.e., made available for viewing, sorting, reporting generation, etc.) to enable next step solutions.

In addition to a traditional reporting system that requires a user to select all the variables they would want to include and then compile the information separately, preferably an embodiment provides an automatic report builder which takes all the key datapoints to include a smart summary that includes both cell data as well as graphs and organizes it in a clear and finalized PDF that is ready for presentation to any client or board with one click.

Preferably, an embodiment of the present invention provides for the detection of robot versus human interaction. As robot interactions become more prevalent, the detection and separation of which from human interaction is key, discarding them based on a series of operating systems, interaction time, speed, connection type, default language, ip, match rate, fingerprints and other various database indexing is important to make sure users are only collecting, targeting and factoring for human counterparts correctly.

An embodiment provides that the database can be examined, searched using parameters, and then the results generated as an output that can be sent to a party who wishes to find matches on their database for targeted marketing or third party outreach.

Preferably, an embodiment of the VR/AR-reality builder is configured to allow users to make their pages ready and optimized for the new environment over traditional web. Similarly, templates that are VR/AR ready are preferably used to expedite this process. Preferably, both versions have identity resolution built in using all of the above methods, as well as next step solutions from matched users.

An embodiment provides a browser extension that can be installed into traditional web browsers as a plugin, use of this plugin pulls items such as top keywords used for promotions of the site, top placements, categories, similar websites, etc. and relays that data back to the dashboard to create a custom targeting and audience that is useable in any of the next step solutions, maps, or contact methods as mentioned throughout.

An embodiment provides API's in and out of the system that allows third party companies to build in conjunction with the platform or integrate its services or data into their product offerings or devices.

An embodiment provides the use of international modeling, wherein the users in the database are taken either from interactions with the product or through searching of variables through the database to create an ideal customer list. This list is then modeled for the international country and given properties that creates an ideal user for expansion or targeting in which the country may not have use of or the ability to collect data on their users in a similar fashion. In some cases, where a minimum number of local users are needed, this can be achieved by rotating in a proprietary ratio of that countries users who are subscribers in order to keep the data accurate and allow large data models to be applied.

An embodiment provides that a call center may integrate its customer list. Specifically, when a matched customer is found, it pings the call center's roster and moves the number up the dial list for consumers who are actively on their device and increases the chances of reaching the consumer. Matched data is then modeled to also give a propensity score of who to dial and when.

An embodiment provides use of embedded product in a VR/AR world, in which an area or landmark in the world could be embedded with code or placed with a relative geo-space or geo-fence area, similar to that of a real-life store front or object within a store. The system provides that interaction with this provides identity resolution as well next step solutions and contact methods for the users.

An embodiment provides that the system is configured to perform identity resolution of participants in a chat room. In other words, the system examines the participants and compares whatever information can be gleamed about that participant to the database of the system to see if the participant can be pinpointed and more complete profile be associated with that participant.

An embodiment of the invention provides a unified system for cross-channel identity resolution and continuous data enrichment, initiated by any user-interaction trigger and extending through automated marketing or analytics actions. The invention integrates several previously separate processes into a coordinated architecture. In various embodiments, a digital trigger—such as a QR code, embedded tracking pixel, hyperlink, NFC tag, or equivalent encoded identifier—initiates the identity-resolution process by transmitting interaction data to the system. The identity-resolution engine then correlates the captured event data with one or more internal and external datasets, including CRM records, third-party enrichment APIs, and behavioral identifiers, using deterministic, probabilistic, or hybrid matching methods to derive a unified identity record.

Following initial resolution, the system performs continuous enrichment through a waterfall process that sequentially or in parallel accesses multiple data sources to append newly available attributes to each user profile. As enriched identity records are generated, they are programmatically transmitted to integrated marketing, analytics, or customer-relationship-management platforms via API to trigger automated campaigns, audience creation, or retargeting actions in real time or in batch mode. A dashboard module may display enriched profiles, campaign results, segmentation, and predictive insights derived from the continuously updated dataset. In certain embodiments, artificial-intelligence or machine-learning models analyze the enriched identity records to generate look-alike audiences or predictive engagement scores, thereby informing downstream marketing or decision-support processes.

The invention may optionally include privacy- and compliance-management features, such as hashing or pseudonymization of personally identifiable data, user-consent tracking, and secure access controls applied to enrichment sources and connected platforms. By combining trigger initiation, multi-source identity resolution, continuous data enrichment, automated activation, and privacy safeguards within a single integrated system, Mermer's invention achieves functionality and scalability not provided by prior single-function marketing or analytics tools.

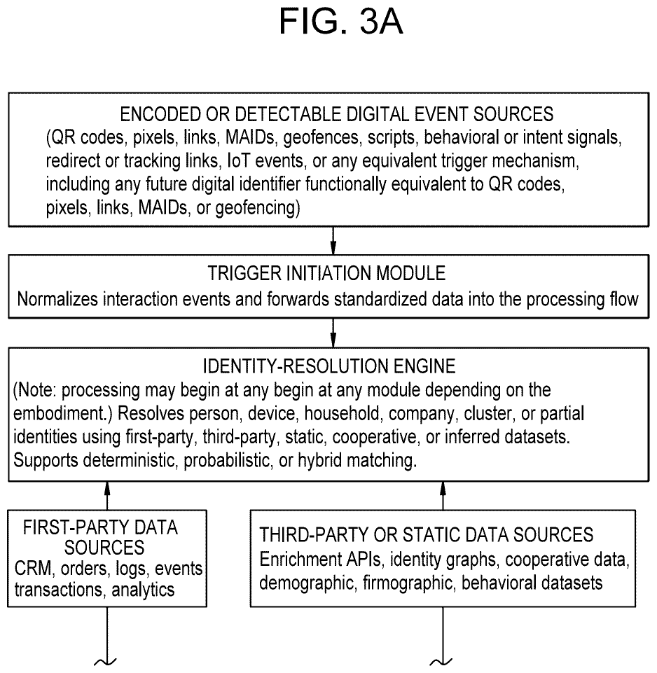

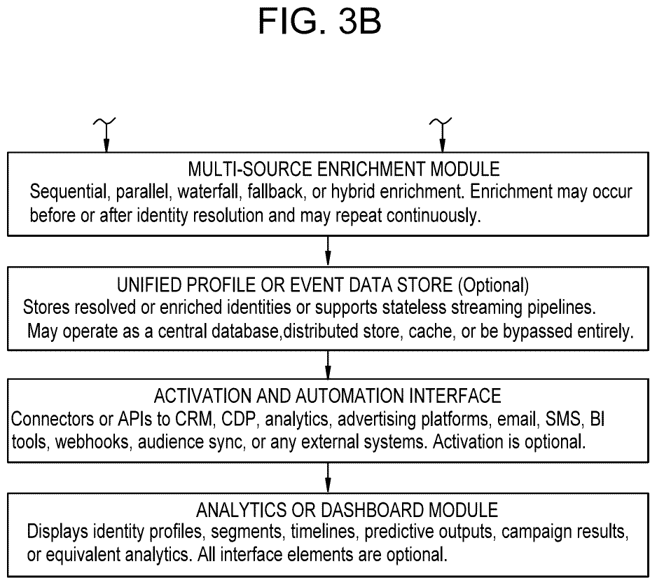

FIGS. 3A and 3B, collectively, provide a schematic block diagram illustrating an exemplary system architecture for cross-channel identity resolution and continuous data enrichment. As shown, the system includes a trigger initiation module, an identity-resolution engine, a data-enrichment module, an automation interface, and an analytics dashboard, all interconnected through a unified data framework. The trigger initiation module receives interaction events generated by encoded identifiers such as QR codes, tracking pixels, hyperlinks, NFC tags, MIADSs, geo-fence entry events, or functionally equivalent future digital triggers and forwards the captured event data to the identity-resolution engine. The identity-resolution engine correlates the data with internal and external databases and passes the resulting identity records to the enrichment module. The enrichment module performs sequential or parallel waterfall enrichment to append additional attributes. The automation interface then distributes the enriched profiles to external marketing or analytics systems, while the analytics dashboard displays aggregated campaign and audience information to an authorized user.

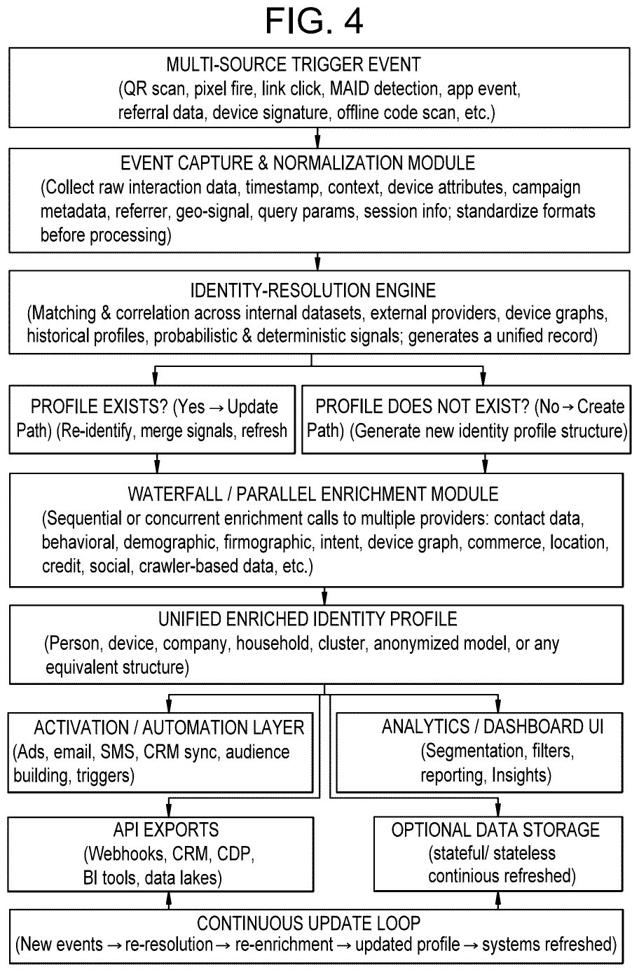

FIG. 4 is a flow diagram depicting an exemplary sequence of operations in which an encoded digital trigger initiates the identity-resolution process. Upon activation of the trigger (such as QR codes, tracking pixels, hyperlinks, NFC tags, MIADSs, geo-fence entry events, or functionally equivalent future digital triggers), interaction data is captured and transmitted to the identity-resolution engine, which performs correlation across multiple datasets to derive a unified identity record. The process continues with waterfall enrichment that sequentially or concurrently queries multiple data sources to append new profile attributes. The enriched record is automatically transmitted to connected marketing or analytics platforms to activate targeted campaigns or audience creation. Updated profile data are continuously fed back into the system to maintain an up-to-date record for ongoing analytics and reporting.

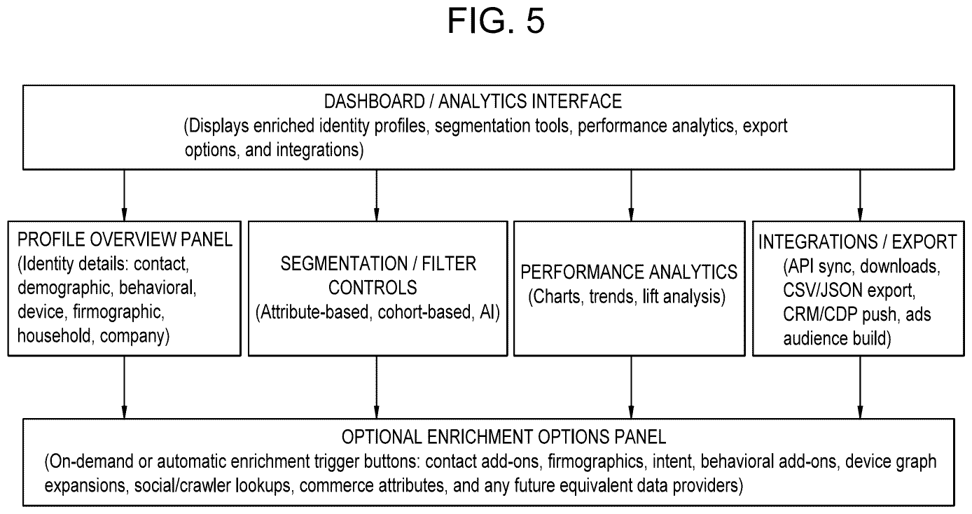

FIG. 5 is a conceptual view of a sample user interface displaying the dashboard module. The dashboard presents enriched identity profiles with associated demographic, behavioral, and campaign information. Segmentation controls allow the user to group and filter profiles according to selected parameters. Predictive-model outputs are displayed alongside campaign-performance analytics, and visual indicators or graphs illustrate engagement rates, audience reach, and conversion outcomes. The dashboard may also include selectable icons for generating reports or exporting data.

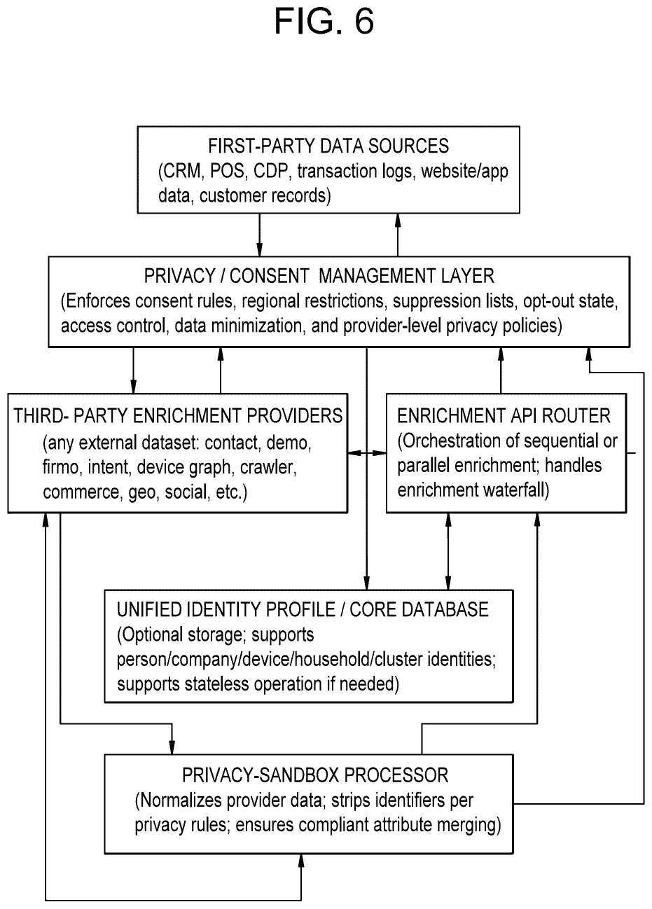

FIG. 6 is a schematic diagram illustrating the interaction between first-party and third-party data sources, enrichment application programming interfaces (APIs), and privacy-management components within the system. The identity-resolution engine receives data from first-party datasets, such as internal CRM systems, and from third-party enrichment providers. Privacy-management components regulate data access and enforce consent requirements. Arrows indicate bidirectional data flow between the enrichment APIs and the system's central database, ensuring that all appended data comply with privacy and consent policies.

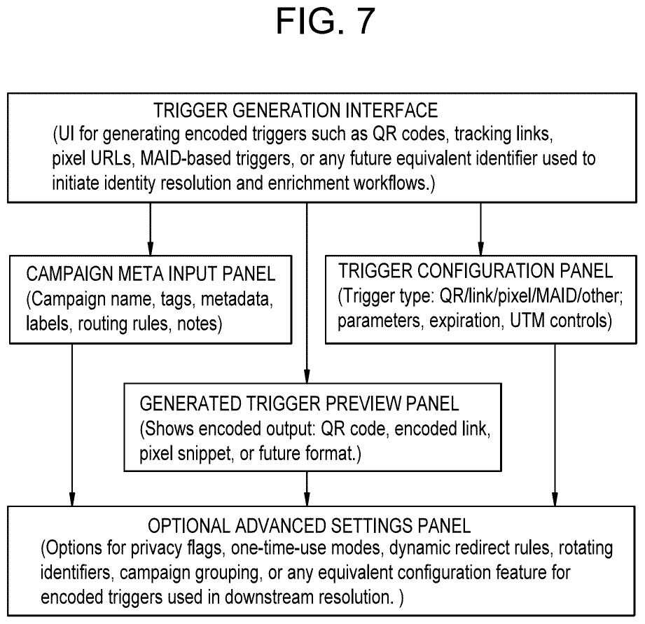

FIG. 7 illustrates the QR-code-generation interface and shows the user-facing aspect of the system. The figure depicts a graphical user interface screen containing input fields for campaign name, tags, and metadata, and a selectable “Generate QR Code” button. A representative QR code symbol is shown as a square icon linked to a corresponding URL. The interface enables users to configure and download campaign-specific codes for distribution in print or digital media.

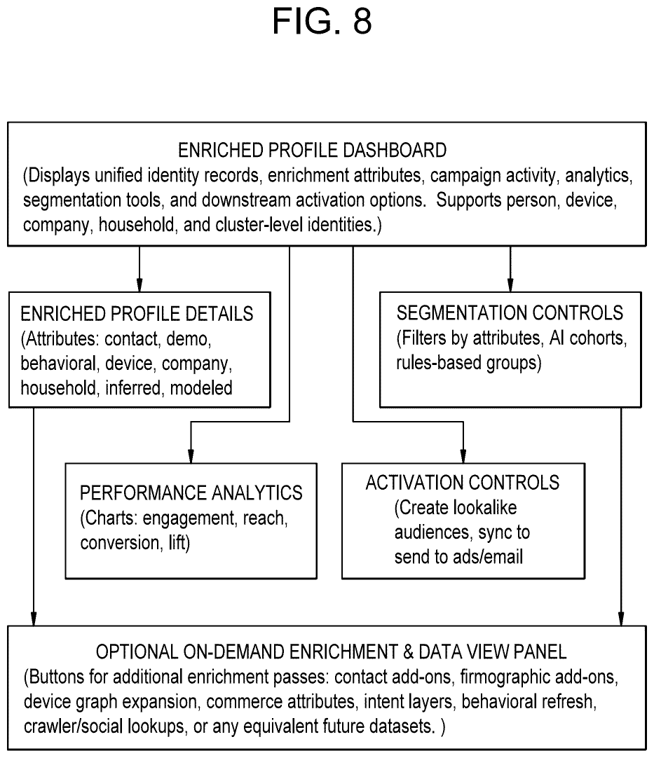

FIG. 8 illustrates the dashboard interface presented to the user following identity resolution and enrichment. The dashboard includes panels displaying user profile data such as contact, demographic, and behavioral attributes, together with campaign-performance charts and visualization widgets. Additional interface elements include filters, segmentation tools, enrichment options, API-integration buttons, and report-export icons, enabling users to customize analyses and transmit results to external systems.

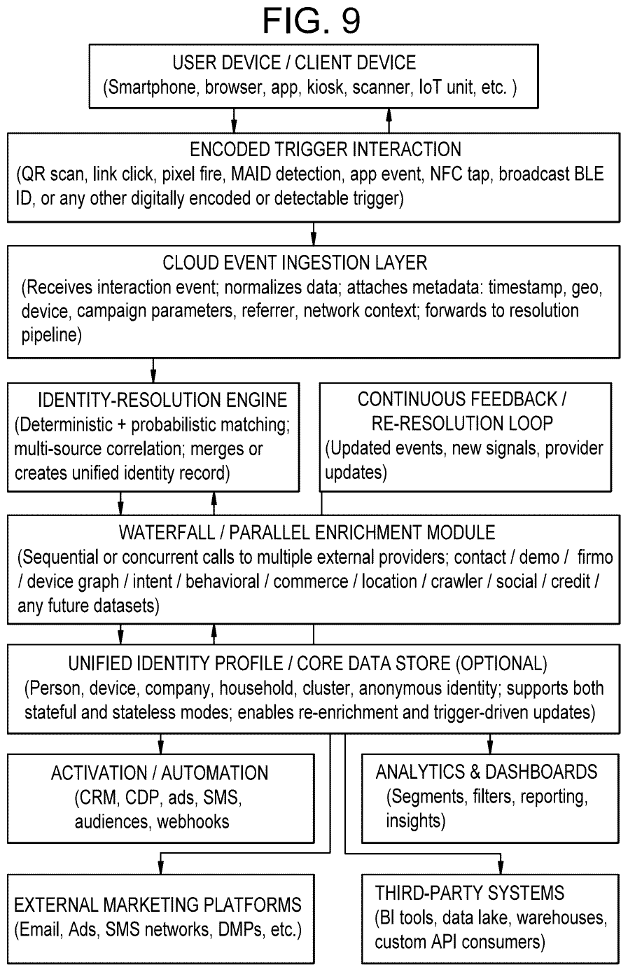

FIG. 9 illustrates the overall data-flow and network environment associated with the invention. The figure shows a user device, such as a smartphone, scanning a QR code and transmitting interaction data to one or more cloud-based servers. Arrows extend from the servers to an internal CRM database, to third-party enrichment APIs, and to external marketing platforms such as e-mail systems or advertising networks. The data-flow paths demonstrate how information is collected, resolved, enriched, and redistributed across connected systems.

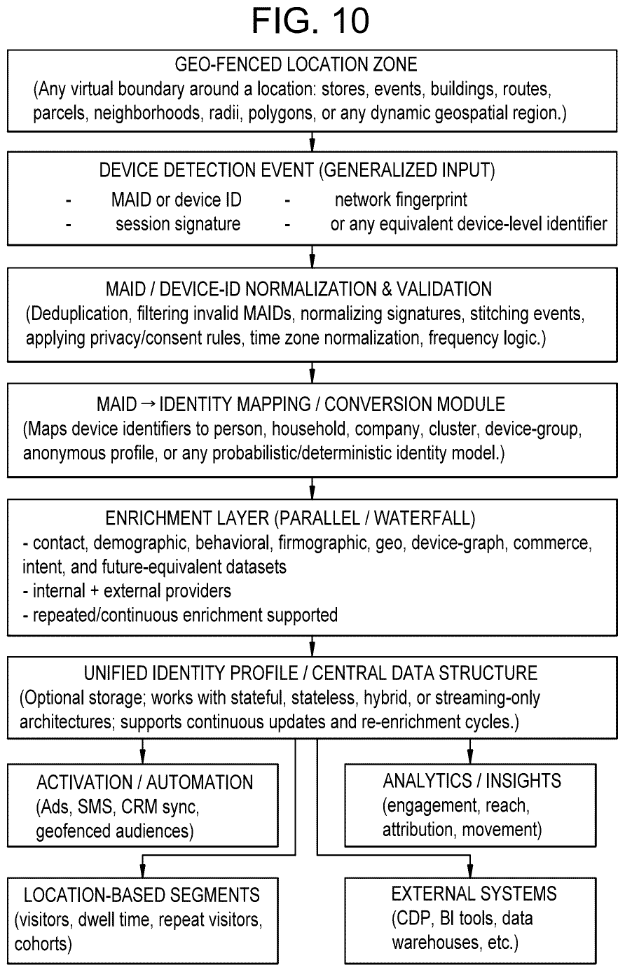

FIG. 10 illustrates geo-fencing and mobile advertising identifier (MAID) conversion as used within the system. A map view depicts multiple geo-fenced zones with user-device icons located within and around defined boundaries. Arrows indicate that device MAIDs detected within a zone are converted into unified identity profiles and stored in the main database. This configuration allows the system to associate location-based interaction data with resolved user identities for enhanced audience targeting and campaign analytics.

Although specific embodiments have been described hereinabove wherein QR codes are used for initiating identity resolution, it should be understood that the embodiments could instead be configured to work with pixels, NFC tags, hyperlinks, MAIDs, geofencing triggers, or any future digital identifier Functionally equivalent to an encoded trigger capable of initiating identity resolution. As such, each module description hereinabove (i.e., trigger initiation, identity resolution, enrichment, activation, analytics) applies regardless of trigger type and are not limited to the scanning of a QR code. The present invention can be configured to effectively encompass future digital identifiers that may supersede or supplement QR codes, pixels, or geofencing technologies. Any encoded object, data string, or interaction-capturing mechanism that performs a substantially similar function of initiating identity resolution is within the scope of the present invention. With regard to all embodiments disclosed herein, all trigger types initiate identical downstream processes including event capture, normalization, identity resolution, waterfall enrichment, and automated activation. The system disclosed herein includes fallback and delay mechanisms to ensure identity resolution is initiated even when in-app browsers, privacy filters, or wrapped links suppress standard parameters. These mechanisms operate the same regardless of trigger type.

Embodiments of the present invention could be configured to cover offline to online transitions, in-app interactions, voice-triggered actions, VR/AR interactions, and any event that can supply minimally identifying metadata sufficient to initiate identity resolution.

While specific embodiments of the invention have been shown and described, it is envisioned that those skilled in the art may devise various modifications without departing from the spirit and scope of the present invention.

What is claimed is:

1. A computer-implemented method for generating an enriched identity profile, comprising:
receiving interaction data generated in response to an encoded or detectable digital event, the encoded or detectable digital event comprising at least one of a QR code, tracking pixel, hyperlink, redirect, script, mobile advertising identifier, and geofence;
performing identity resolution by correlating the interaction data with one or more datasets to determine an identity comprising at least one of a person, device, household, company, or partial identity;
performing multi-source enrichment on the resolved identity using sequential, parallel, or waterfall queries to a plurality of enrichment providers or datasets; and
transmitting the enriched identity profile to one or more external systems for activation, analytics, segmentation, or further processing.

2. A system comprising one or more processors configured to:
receive interaction data generated by an encoded or detectable digital event;
execute identity-resolution processes and enrichment processes in any order including identity-first, enrichment-first, sequential, parallel, or repeated processing; and
output an enriched identity profile to an external system, data store, or streaming pipeline.

3. A computer-implemented method comprising:
receiving interaction data from an encoded or detectable digital event;
identifying an entity associated with the interaction data; and
applying a waterfall enrichment process comprising sequentially querying multiple enrichment providers until data is obtained that augments the entity profile.

4. A computer-implemented method comprising:
detecting a location-based digital event comprising at least one of a mobile advertising identifier, GPS signal, Wi-Fi signal, Bluetooth beacon, IP-based location or cellular-based location;
associating the location-based event with an identity comprising a person, device, household, or company; and
enriching the identity using one or more third-party or first-party datasets.

5. The method of claim 1, wherein the encoded or detectable digital event comprises a QR code.

6. The method of claim 1, wherein the encoded or detectable digital event comprises a tracking pixel.

7. The method of claim 1, wherein the encoded or detectable digital event comprises a hyperlink or redirect.

8. The method of claim 1, wherein the encoded or detectable digital event comprises a mobile advertising identifier.

9. The method of claim 1, wherein the encoded or detectable digital event comprises a geofence entry or exit.

10. The method of claim 1, wherein the identity comprises a person.

11. The method of claim 1, wherein the identity comprises a device.

12. The method of claim 1, wherein the identity comprises a household.

13. The method of claim 1, wherein the identity comprises a company or organization.

14. The method of claim 1, wherein the identity comprises a partially resolved identity.

15. The method of claim 1, wherein multi-source enrichment is performed sequentially.

16. The method of claim 1, wherein multi-source enrichment is performed repeatedly as part of a continuous enrichment cycle.

17. The method of claim 1, wherein enrichment comprises modeled or inferred attributes.

18. The method of claim 1, wherein enrichment comprises merging static datasets with real-time datasets.

19. The method of claim 1, further comprising automatically initiating, based on the enriched identity profile, at least one next-step action selected from: updating a record in a customer-relationship-management system, creating a remarketing audience in a digital advertising platform, triggering a direct-mail campaign, or generating a personalized electronic communication.

20. The system of claim 2, wherein the one or more processors are further configured to provide an analytics dashboard that displays enriched identity profiles together with segmentation controls, campaign-performance metrics, and predictive scores generated by applying artificial-intelligence or machine-learning models to the enriched identity profiles.

21. The method of claim 1, further comprising applying artificial-intelligence or machine-learning models to the enriched identity profile to generate at least one of: a predictive engagement score, a propensity-to-purchase score, or a look-alike audience definition.

22. The method of claim 1, further comprising enforcing privacy-management controls by at least one of hashing or pseudonymizing personally identifiable information, tracking user consent associated with the enriched identity profile, and restricting access to the enriched identity profile based on role or policy.

23. The method of claim 1, wherein receiving interaction data further comprises receiving traffic from a tracking pixel that is configured as a fake or non-visible pixel, and wherein interactions associated with the fake or non-visible pixel are classified as automated or bot traffic and excluded from the enriched identity profile.

24. The method of claim 1, wherein the encoded or detectable digital event occurs within an in-app browser or wrapped link environment, and further comprising introducing at least one of: a timed delay, an intermediate click, or a redirect sequence to ensure that interaction parameters are propagated to enable identity resolution.

25. The method of claim 1, wherein the encoded or detectable digital event is presented within a virtual-reality or augmented-reality environment, and wherein receiving interaction data comprises detecting user gaze, selection, or interaction with a virtual object corresponding to the encoded or detectable digital event.

26. The method of claim 4, further comprising associating the location-based digital event with at least one out-of-home advertising placement and generating audience segments corresponding to devices detected within a geo-fenced region surrounding the placement.

27. The method of claim 1, further comprising transmitting the enriched identity profile to a call-center system and adjusting the position of a corresponding contact record in a dialing queue based on at least one of: recent device activity, engagement history, or a propensity score derived from the enriched identity profile.

28. The method of claim 1, wherein the encoded or detectable digital event is embedded within an electronic newsletter or e-mail container, and receiving interaction data comprises detecting views or clicks on the embedded content and performing identity resolution for recipients who interact with the newsletter or e-mail.
